(19) United States
(12) Patent Application Publication
(10) Pub. No.: US 2025/0272129 A1
(43) Pub. Date: Aug. 28, 2025

(54) System and method for virtual machine allocation and container placement

(71) Applicant: Bank of America Corporation, Charlotte, NC (US)

(72) Inventors: Jeevitha Gopinath, Chennai (IN); Jigesh Rajendra Safary, Mumbai (IN); Durga Prasad Kutthumolu, Hyderabad (IN)

(21) Appl. No.: 18/586,331

(22) Filed: Feb. 23, 2024

(51) Int. Cl. G06F 9/455

(52) U.S. Cl. CPC G06F 9/45558; G06F 2009/4557

(57) ABSTRACT

A first computing node receives information pertaining to a predefined objective, and determines a first result including a first VM allocation and a first container placement strategy to achieve the predefined objective. A second computing node receives the information pertaining to the predefined objective, and determines a second result that includes a second VM allocation and a second container placement strategy. A third processor receives the first result and determines a first fitness value based upon time taken by the first computing node to complete a task and an energy consumed by the first computing node. The third processor receives the second result and determines a second fitness value based upon taken by the second computing node to complete a task and an energy consumed by the second computing node. The highest fitness value is output with the VM allocation and the container placement strategy.

### TECHNICAL FIELD

The present disclosure relates generally to cloud computing, and more specifically to a system and method for virtual machine allocation and container placement.

### BACKGROUND

Cognitive operating systems need to be energy efficient and cost effective compared to other operating systems. In existing cognitive operating systems, operations such as container placement and virtual machine allocation are performed using a centralized algorithm in which the decision-making process is performed in a centralized manner. As a result, bottlenecks are created and efficiency is reduced. These challenges become more pronounced when the amount of data to be processed increases.

### SUMMARY

The system disclosed in the present disclosure provides technical solutions to the technical problems discussed above by determining virtual machine allocation and container placement strategy.

Embodiments of the disclosure are directed to virtual machine allocation and container placement using a composite objective function and with an objective to reduce energy consumption and improve energy efficiency of the system, among others. Other embodiments are directed to virtual machine allocation and container placement based on other objectives such as the more efficient use of processing resources (e.g., CPU usage), memory, network bandwidth, etc. Based on the desired objective, a composite objective function is defined. The composite objective function includes terms relating to the objective to be achieved. For instance, for reducing energy utilization, the composite objective function is based on the energy consumption, response time, and resource utilization of the different computing nodes of the operating system that are used to solve the composite objective function. The computing nodes solve the composite objective function individually, and each computing node produces a result (decision). A fitness value is determined based at least in part upon the result from each computing node. Each fitness value is determined based at least in part upon time taken by the respective computing node to complete a task and energy consumed by the respective computing node. A highest fitness value is identified from among the multiple fitness values, and a solution is output that includes the virtual machine allocation and the container placement strategy according to one of the results that has the identified highest fitness value.

In certain embodiments, this disclosure may particularly be integrated into a practical application of a computer system for determining a virtual machine allocation and container placement strategy that uses a specially structured algorithm to determine an improved solution for virtual machine allocation and container placement. This analysis may be geared towards reducing bottlenecks and inefficiencies in cognitive operating systems. The process may improve the underlying computing system in several ways. First, a more efficient virtual machine allocation and container placement may increase the throughput of the system. Second, it may reduce resource (e.g., processor, memory) utilization in the system and free up resources for other tasks or processes.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a system in accordance with one or more embodiments of the present disclosure; and

FIG. 2 illustrates a flowchart of an example method for determining virtual machine allocation and the container placement strategy, in accordance with one or more embodiments of the present disclosure.

### DETAILED DESCRIPTION

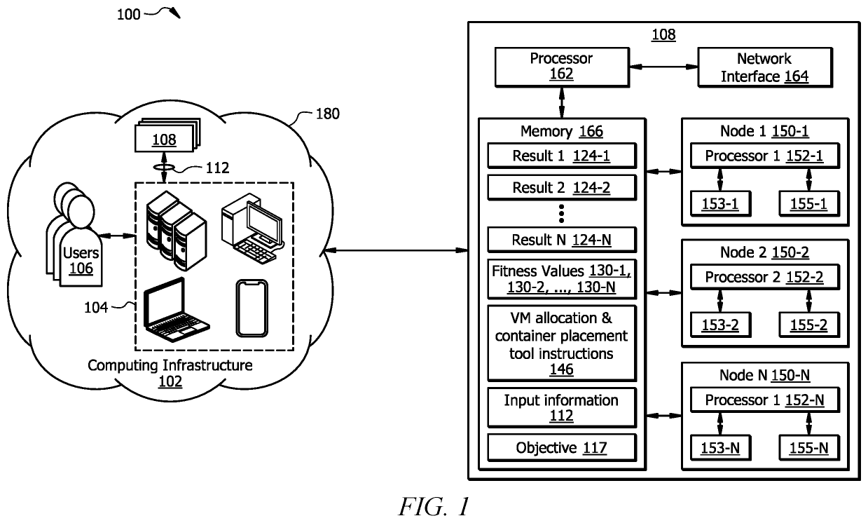

FIG. 1 is a schematic diagram of a system 100 that includes a computing infrastructure 102 connected to a network 180 and tool 108. Embodiments of the disclosure are directed to virtual machine allocation and container placement using a composite objective function and with an objective to reduce energy consumption and improve energy efficiency of the system, among others. Other embodiments are directed to virtual machine allocation and container placement based on other objectives such as more efficient use of processing resources (e.g., CPU usage), memory, network bandwidth, etc. As described in further detail below, these techniques provide a virtual machine allocation and the container placement strategy to achieve the desired objective. For the purposes of discussion herein, virtual machine allocation (and variations thereof) refers to assigning or provisioning virtual machine on host machine for managing and deploying services in an operating system (e.g., cognitive operating system), and the like. For the purposes of discussion herein, container placement (and variations thereof) refers to mapping containers to virtual machines for managing containers for deploying services in an operating system (e.g., cognitive operating system), and the like.

Computing infrastructure 102 may include a plurality of hardware and software components. The hardware components may include, but are not limited to, computing devices 104 such as desktop computers, tablet computers, laptop computers, servers and data centers, mainframe computers, and other hardware devices such as printers, routers, hubs, switches, and memory all connected to the network 180. Software components may include software applications that are run by one or more of the computing devices 104 including, but not limited to, operating systems, user interface applications, third party software, database management software, service management software, mainframe software, virtual machine (VM) allocation and container placement tools (e.g., tool 108) and other customized software programs implementing particular functionalities. For example, software code relating to one or more software applications may be stored in a memory device and one or more processors (e.g., belonging to one or more computing devices 104) may execute the software code to implement respective functionalities. For example, software applications run by one or more computing devices 104 of the computing infrastructure 102 may include virtual machine (VM) allocation and container placement tools 108.

One or more of the computing devices 104 may be operated by a user 106 to perform data interactions within the computing infrastructure 102.

One or more computing devices 104 of the computing infrastructure 102 may be representative of a computing system which hosts software applications that may be installed and run locally or may be used to access software applications running on a server. The computing system may include mobile computing systems including smart phones, tablet computers, laptop computers, or any other mobile computing devices or systems capable of running software applications and communicating with other devices. The computing system may also include non-mobile computing devices such as desktop computers or other non-mobile computing devices capable of running software applications and communicating with other devices. In certain embodiments, one or more of the computing devices 104 may be representative of a server running one or more software applications to implement respective functionality (e.g., tool 108) as described below. In certain embodiments, one or more of the computing devices 104 may run a thin client software application where the processing is directed by the thin client but largely performed by a central entity such as a server.

The network 180, in general, may be a wide area network (WAN), a personal area network (PAN), a cellular network, or any other technology that allows devices to communicate electronically with other devices. In one or more embodiments, network 180 may be the Internet.

At least a portion of the computing infrastructure 102 (e.g., one or more computing device 104) may implement the tool 108 which may perform a plurality of operations associated with virtual machine allocation and the container placement strategy. The tool 108 comprises a processor 162, a memory 166, a network interface 164, and a plurality of computing nodes 150-1, 150-2, . . . , 150-N (collectively computing nodes 150). The tool 108 may be configured as shown in FIG. 1 or in any other suitable configuration.

The processor 162 comprises one or more processors operably coupled to the memory 166. The processor 162 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 162 may be a programmable logic device, a microcontroller, a microprocessor, or any suitable combination of the preceding. The processor 162 is communicatively coupled to and in signal communication with the memory 166. The one or more processors are configured to process data and may be implemented in hardware or software. For example, the processor 162 may be 8-bit, 16-bit, 32-bit, 64-bit or of any other suitable architecture. The processor 162 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

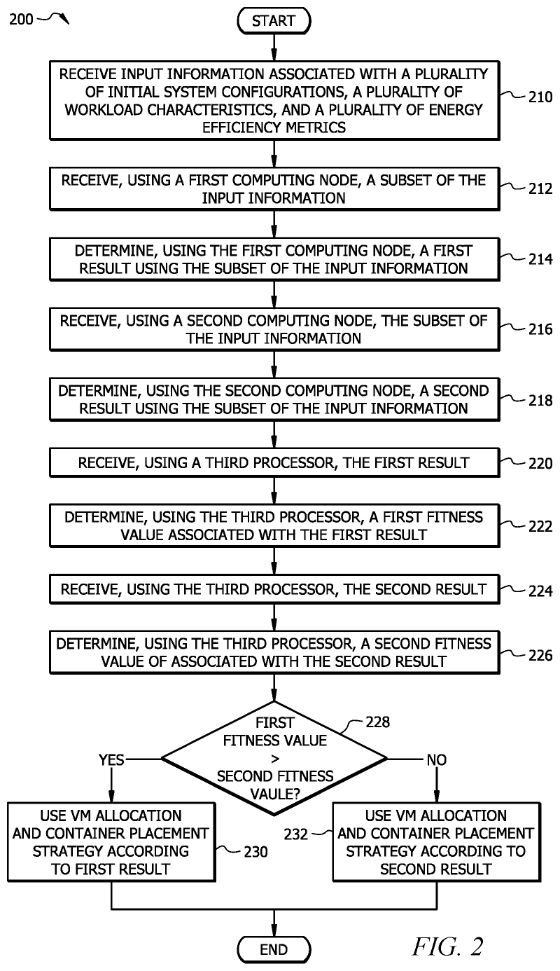

The one or more processors 162 are configured to execute instructions (e.g., VM allocation and container placement tool instructions 146) to implement the VM allocation and container placement tool 108 using the input information 112. In an embodiment, and discussed below, the input information 112 includes one or more of a plurality of initial system configurations, a plurality of workload characteristics, or a plurality of energy efficiency metrics that the tool 108 uses for performing the various tasks disclosed herein. In this way, processor 162 may be a special-purpose computer designed to implement the functions disclosed herein. The tool 108 is configured to operate as described with reference to FIG. 2. For example, the processor 162 may be configured to perform at least a portion of the method 200 as described in FIG. 2.

The memory 166 comprises a non-transitory computer-readable medium such as one or more disks, tape drives, or solid-state drives, and may be used as an over-flow data storage device, to store programs when such programs are selected for execution, and to store instructions and data that are read during program execution. The memory 166 may be volatile or non-volatile and may comprise a read-only memory (ROM), random-access memory (RAM), ternary content-addressable memory (TCAM), dynamic random-access memory (DRAM), and static random-access memory (SRAM).

The memory 166 is operable to store results 124-1, 124-2, . . . , 124-N (collectively referred to as results 124), plurality of fitness values 130, and the VM allocation and container placement tool instructions 146. The VM allocation and container placement tool instructions 146 may include any suitable set of instructions, logic, rules, or code operable to execute the VM allocation and container placement tool 108.

The network interface 164 is configured to enable wired and/or wireless communications with other elements of system 100. The network interface 164 is configured to communicate data between the VM allocation and container placement tool 108 and other devices, systems, or domains (e.g., computing devices 104). For example, the network interface 164 may comprise a Wi-Fi interface, a LAN interface, a WAN interface, a modem, a switch, or a router. The processor 162 is configured to send and receive data using the network interface 164. The network interface 164 may be configured to use any suitable type of communication protocol as would be appreciated by one of ordinary skill in the art.

The computing nodes 150 each include corresponding processors 152-1, 152-2, . . . , 152-N (collectively processors 152) that implement at least a portion of the VM allocation and container placement tool instructions 146 to generate the respective results 124. Each processor 152 may be coupled to a memory resource 153-1, 153-2, . . . , 153+N and hardware/software resources 155-1, 155-2, . . . , 155-N (e.g., communication interface, operating system, drivers, etc.) that processor 152 can access when executing the VM allocation and container placement tool instructions 146.

The VM allocation and container placement tool 108 may be configured to generate the virtual machine allocation and the container placement strategy based on a predefined (or desired) objective 117 and the input information 112. The input information 112 includes one or more of a plurality of initial system configurations, a plurality of workload characteristics, and a plurality of energy efficiency metrics. For example, the initial system configurations may include a list of virtual machines to be initially configured on one or more of the computing nodes 150 and a list of containers to be initially configured on one or more of the computing nodes 150. The initial system configuration may also include power consumption of the system, the cooling capabilities of the system, and network topology. The workload characteristics, for example, may include the resource requirements (e.g., CPU, memory, disk space,) of the virtual machines and containers, memory and storage availability of the system, and predicted workload demands of the virtual machines and containers. For example, the energy efficiency metrics may include the energy consumption profiles of the computing nodes 150. The predefined objective 117 is a user defined criteria for satisfying certain condition when determining a virtual machine allocation and the container placement strategy. For instance, if the predefined objective 117 relates to minimizing energy utilization, then the predefined objective 117 is considered to be satisfied when the process, as discussed herein, obtains a virtual machine allocation and container placement strategy that has the least energy consumption. The obtained virtual machine allocation and the container placement strategy will then be implemented in the system 100.

The virtual machine (VM) allocation and container placement tool 108 is configured to receive the input information 112 and store the input information 112 in the memory 166. In some embodiments, the input information 112 may be received from the computing devices 104. Depending on the objective to be satisfied, a subset of the information 112 pertaining to the predefined objective 117 is provided to the computing nodes 150. In some embodiments, the predefined objective 117 may relate to reducing energy utilization on each of the first computing node 150-1 and the second computing node 150-2. The predefined objective 117 may be further based on a plurality of sub-objectives. In one embodiment, the sub-objectives may include energy consumption by the computing nodes 150, a response time of the computing nodes 150, and a resource utilization by the computing nodes 150. Energy consumption sub-objective may be directed to reducing the energy consumption by all the computing nodes 150. Response time sub-objective may be directed to reducing the response time of all the computing nodes 150. Similarly, resource utilization sub-objective may be directed to reducing the resources used by all the computing nodes 150. In some embodiments, each sub-objective is individually weighted when determining the predefined objective 117. Considering that the predefined objective 117 is represented as ƒ(x) and the plurality of sub-objectives are represented as ƒ(x1), ƒ(x2), ƒ(x3), then the predefined objective 117 can be expressed as ƒ(x)=w1ƒ(x1)+w2ƒ(x2)+w3ƒ(x3). Herein, w1, w2, w3 are user-defined weights for the sub-objectives ƒ(x1), ƒ(x2), ƒ(x3), respectively. The weights w1, w2, w3 are based on energy consumption, response time, and/or resource utilization of each computing node 150 based on the objective. The weights w1, w2, w3 are determined based on the input information 112 including the plurality of initial system configurations, the plurality of workload characteristics, and/or the plurality of energy efficiency metrics.

In some embodiments, using the subset of the information 112 provided thereto, each computing node 150, using a respective processor 152, individually determines a result 124 that includes a virtual machine allocation and a container placement strategy to achieve the predefined objective 117. Thus, the computing node 150-1 provides result 124-1, the computing node 150-2 provides a result 124-2, and so on. In some embodiments, a fitness value 130 is determined for each individual result 124. For example, the processor 162 obtains the individual results 124 and assigns each result 124 a corresponding fitness value 130. Each fitness value 130 is determined based at least in part upon time taken by the corresponding computing node 150 to complete a task and energy consumed by the computing node 150. In calculating the fitness value 130, each term, the time taken and the energy consumed, is assigned a user defined, computing node specific weighted coefficient. In an embodiment, the user defined weighted coefficient assigned to the time taken by the first computing node to complete the task is based on the static power coefficients and the dynamic power coefficients of the first processor, and the user defined weighted coefficient assigned to the energy consumed by the first computing node is based on the static power coefficients and the dynamic power coefficients of the memory usage of the first computing node. The result having the highest fitness value obtained from the process above is considered to be the virtual machine allocation and the container placement strategy that will be implemented in the system 100.

FIG. 2 illustrates a flowchart of an example method 200 for determining virtual machine allocation and the container placement strategy, in accordance with one or more embodiments of the present disclosure. It is understood that additional operations can be provided before, during, and after the operations in FIG. 2, and some of the operations described below can be replaced or eliminated, for additional embodiments of the method. The order of the operations/processes may be interchangeable, or two or more operations can be performed simultaneously. The method 200 may be performed by the VM allocation and container placement tool 108 illustrated in FIG. 1.

At operation 210, the tool 108 receives input information 112 (FIG. 1) associated with a plurality of initial system configurations, a plurality of workload characteristics, and a plurality of energy efficiency metrics. For example, the initial system configurations may include a list of virtual machines to be initially configured on one or more of the computing nodes 150 and a list of containers to be initially configured on one or more of the computing nodes 150. The initial system configuration may also include power consumption of the system, the cooling capabilities of the system, and network topology. The workload characteristics, for example, may include the resource requirements (e.g., CPU, memory, disk space,) of the virtual machines and containers, memory and storage availability of the system, and predicted workload demands of the virtual machines and containers. For example, the energy efficiency metrics may include the energy consumption profiles of the computing nodes 150. As illustrated in FIG. 1, the input information 112 is stored in the memory 166.

At operation 212, a subset of the input information 112 pertaining to a predefined (or desired) objective 117 that is to be achieved is received using a first computing node 150-1.

At operation 214, the first computing node determines a first result using the subset of the input information 112.

At operation 216, a second computing node receives the subset of the input information pertaining to the predefined objective 117.

At operation 218, the second computing node determines a second result 124-2 using the subset of the input information 112. According to embodiments, the second result 124-2 includes a second virtual machine allocation and a second container placement strategy to achieve the predefined objective 117. Referring to operations 212, 214, 216, and 218, the predefined objective 117 is a user defined criteria for satisfying certain condition when determining a virtual machine allocation and the container placement strategy. For instance, if the predefined objective 117 relates to minimizing energy utilization, then the predefined objective 117 is considered to be satisfied when the process, as discussed herein, obtains a virtual machine allocation and container placement strategy that has the least energy consumption. Depending on the objective to be satisfied, a subset of the information 112 pertaining to the predefined objective 117 is provided to the computing nodes 150. In some embodiments, the predefined objective 117 may relate to reducing energy utilization on each of the first computing node 150-1 and the second computing node 150-2. The predefined objective 117 may be further based on a plurality of sub-objectives. In one embodiment, the sub-objectives may include energy consumption by the computing nodes 150, a response time of the computing nodes 150, and a resource utilization by the computing nodes 150. Energy consumption sub-objective may be directed to reducing the energy consumption by all the computing nodes 150. Response time sub-objective may be directed to reducing the response time of all the computing nodes 150. Similarly, resource utilization sub-objective may be directed to reducing the resources used by all the computing nodes 150. In some embodiments, each sub-objective is individually weighted when determining the predefined objective 117. Each computing node 150 individually determines a result 124 that includes a virtual machine allocation and a container placement strategy to achieve the predefined objective 117.

At operation 220, the processor 162 receives the first result.

At operation 222, the processor 162 determines a first fitness value 130-1 associated with the first result. According to embodiments, the first fitness value is determined based at least in part upon time taken by the first computing node 150-1 to complete a task and energy consumed by the first computing node 150-1.

At operation 224, the processor 162 receives the second result.

At operation 226, the third processor determines a second fitness value 130-2 associated with the second result. According to embodiments, the second fitness value is determined based at least in part upon time taken by the second computing node 150-2 to complete a task and energy consumed by the second computing node 150-2. Referring to operations 220, 222, 224, and 226, in some embodiments, a fitness value 130 is determined for each individual result 124. For example, the processor 162 obtains the individual results 124 and assigns each result 124 a corresponding fitness value 130. Each fitness value 130 is determined based at least in part upon time taken by the corresponding computing node 150 to complete a task and energy consumed by the computing node 150. In calculating the fitness value 130, each term, the time taken and the energy consumed, is assigned a user defined, computing node specific weighted coefficient.

At operation 228, the processor 162 checks whether the first fitness value 130-1 is greater than the second fitness value 130-2.

If the first fitness value 130-1 is greater than the second fitness value 130-2, then at operation 230, the virtual machine allocation and the container placement strategy according to the first result is considered as the one that meets the objective. For instance, when the predefined objective 117 relates to minimizing energy utilization, the first result is considered to provide the virtual machine allocation and container placement strategy that has the least energy consumption.

If at operation 228, it is determined that the second fitness value 130-2 is greater than the first fitness value 130-1, then at operation 232, the virtual machine allocation and the container placement strategy according to the second result is considered as the one that meets the predefined objective 117. For instance, when the predefined objective 117 relates to minimizing energy utilization, the second result is considered to provide the virtual machine allocation and container placement strategy that has the least energy consumption.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system, comprising:
a memory operable to store information associated with a plurality of initial system configurations, a plurality of workload characteristics, and a plurality of energy efficiency metrics;
a first computing node comprising a first processor operably coupled to the memory and configured to:
receive a subset of the information pertaining to a predefined objective that is to be achieved; and
determine a first result using the subset of the information, wherein the first result includes a first virtual machine allocation and a first container placement strategy to achieve the predefined objective;
a second computing node comprising a second processor operably coupled to the memory and configured to:
receive the subset of the information pertaining to the predefined objective that is to be achieved; and
determine a second result using the subset of the information, wherein the second result includes a second virtual machine allocation and a second container placement strategy to achieve the predefined objective; and
a third processor operably coupled to the first computing node and the second computing node, the third processor configured to:
receive the first result;
determine a first fitness value associated with the first result, wherein the first fitness value is determined based at least in part upon time taken by the first computing node to complete a task and an energy consumed by the first computing node;
receive the second result;
determine a second fitness value associated with the second result, wherein the second fitness value is determined based at least in part upon time taken by the second computing node to complete a task and an energy consumed by the second computing node;
identify a highest fitness value from among the first fitness value and the second fitness value; and
output a solution with the virtual machine allocation and the container placement strategy according to the first result or the second result that has the identified highest fitness value.

2. The system of claim 1, wherein the predefined objective relates to minimizing energy utilization on each of the first computing node and the second computing node, and the predefined objective is based on a plurality of sub-objectives including energy consumption by the first computing node and the second computing node, a response time of the first computing node and the second computing node, and resource utilization by the first computing node and the second computing node, and wherein each sub-objective is individually weighted.

3. The system of claim 1, wherein the predefined objective relates to minimizing energy utilization and the third processor is configured to determine that the first result or the second result that has the highest fitness value provides the virtual machine allocation and container placement strategy that has the least energy consumption.

4. The system of claim 1, wherein, in determining the first fitness value, the time taken by the first computing node to complete the task and the energy consumed by the first computing node are each assigned a user defined weighted coefficient.

5. The system of claim 4, wherein the user defined weighted coefficient assigned to the time taken by the first computing node to complete the task is based on the static power coefficients and the dynamic power coefficients of the first processor, and the user defined weighted coefficient assigned to the energy consumed by the first computing node is based on the static power coefficients and the dynamic power coefficients of the memory usage of the first computing node.

6. The system of claim 1, wherein, in determining the second fitness value, the time taken by the second computing node to complete the task and the energy consumed by the second computing node are each assigned a user defined weighted coefficient.

7. The system of claim 6, wherein the user defined weighted coefficient assigned to the time taken by the second computing node to complete the task is based on the static power coefficients and the dynamic power coefficients of the second processor, and the user defined weighted coefficient assigned to the energy consumed by the second computing node is based on the static power coefficients and the dynamic power coefficients of the memory usage of the second computing node.

8. A method, comprising:
storing, in a memory, information associated with a plurality of initial system configurations, a plurality of workload characteristics, and a plurality of energy efficiency metrics;
receiving, using a first computing node that includes a first processor operably coupled to the memory, a subset of the information pertaining to a predefined objective that is to be achieved;
determining, using the first computing node, a first result using the subset of the information, wherein the first result includes a first virtual machine allocation and a first container placement strategy to achieve the predefined objective;
receiving, using a second computing node that includes a second processor operably coupled to the memory, the subset of the information pertaining to the predefined objective that is to be achieved;
determining, using a second computing node, a second result using the subset of the information, wherein the second result includes a second virtual machine allocation and a second container placement strategy to achieve the predefined objective;
receiving, using a third processor operably coupled to the first computing node and the second computing node, the first result;
determining, using the third processor, a first fitness value associated with the first result, wherein the first fitness value is determined based at least in part upon time taken by the first computing node to complete a task and an energy consumed by the first computing node;
receiving, using the third processor, the second result;
determining, using the third processor, a second fitness value associated with the second result, wherein the second fitness value is determined based at least in part upon time taken by the second computing node to complete a task and an energy consumed by the second computing node;
identifying, using the third processor, a highest fitness value from among the first fitness value and the second fitness value; and
outputting, using the third processor, a solution with the virtual machine allocation and the container placement strategy according to the first result or the second result that has the identified highest fitness value.

9. The method of claim 8, wherein the predefined objective relates to minimizing energy utilization on each of the first computing node and the second computing node, and the predefined objective is based on a plurality of sub-objectives including energy consumption by the first computing node and the second computing node, a response time of the first computing node and the second computing node, and resource utilization by the first computing node and the second computing node, and wherein each sub-objective is individually weighted.

10. The method of claim 8, wherein the predefined objective relates to minimizing energy utilization, and the method further comprises:
determining, using the third processor, that the first result or the second result that has the highest fitness value provides the virtual machine allocation and container placement strategy that has the least energy consumption.

11. The method of claim 8, further comprising:
determining the first fitness value by assigning a user defined weighted coefficient to each of the time taken by the first computing node to complete the task and the energy consumed by the first computing node.

12. The method of claim 11, wherein the user defined weighted coefficient assigned to the time taken by the first computing node to complete the task is based on the static power coefficients and the dynamic power coefficients of the first processor, and the user defined weighted coefficient assigned to the energy consumed by the first computing node is based on the static power coefficients and the dynamic power coefficients of the memory usage of the first computing node.

13. The method of claim 8, further comprising:
determining the second fitness value by assigning a user defined weighted coefficient to each of the time taken by the second computing node to complete the task and the energy consumed by the second computing node.

14. The method of claim 13, wherein the user defined weighted coefficient assigned to the time taken by the second computing node to complete the task is based on the static power coefficients and the dynamic power coefficients of the second processor, and the user defined weighted coefficient assigned to the energy consumed by the second computing node is based on the static power coefficients and the dynamic power coefficients of the memory usage of the second computing node.

15. A non-transitory computer-readable medium storing instructions that when executed by a processor cause the processor to:
store, in a memory, information associated with a plurality of initial system configurations, a plurality of workload characteristics, and a plurality of energy efficiency metrics;
receive, using a first computing node, a subset of the information pertaining to a predefined objective that is to be achieved;
determine, using the first computing node, a first result using the subset of the information, wherein the first result includes a first virtual machine allocation and a first container placement strategy to achieve the predefined objective;
receive, using a second computing node, the subset of the information pertaining to the predefined objective that is to be achieved;
determine a second result using the subset of the information, wherein the second result includes a second virtual machine allocation and a second container placement strategy to achieve the predefined objective;
receive the first result;
determine a first fitness value associated with the first result, wherein the first fitness value is determined based at least in part upon time taken by the first computing node to complete a task and an energy consumed by the first computing node;
receive the second result;
determine a second fitness value associated with the second result, wherein the second fitness value is determined based at least in part upon time taken by the second computing node to complete a task and an energy consumed by the second computing node;
identify a highest fitness value from among the first fitness value and the second fitness value; and
output a solution with the virtual machine allocation and the container placement strategy according to the first result or the second result that has the identified highest fitness value.

16. The non-transitory computer-readable medium of claim 15, wherein the predefined objective relates to minimizing energy utilization, and wherein the instructions further cause the processor to:
determine that the first result or the second result that has the highest fitness value provides the virtual machine allocation and container placement strategy that has the least energy consumption.

17. The non-transitory computer-readable medium of claim 15, wherein the instructions further cause the processor to:
determine the first fitness value by assigning a user defined weighted coefficient to each of the time taken by the first computing node to complete the task and the energy consumed by the first computing node.

18. The non-transitory computer-readable medium of claim 17, wherein
the user defined weighted coefficient assigned to the time taken by the first computing node to complete the task is based on the static power coefficients and the dynamic power coefficients of the first processor, and
the user defined weighted coefficient assigned to the energy consumed by the first computing node is based on the static power coefficients and the dynamic power coefficients of the memory usage of the first computing node.

19. The non-transitory computer-readable medium of claim 15, wherein the instructions further cause the processor to:
determine the second fitness value by assigning a user defined weighted coefficient to each of the time taken by the second computing node to complete the task and the energy consumed by the second computing node.

20. The non-transitory computer-readable medium of claim 19, wherein
the user defined weighted coefficient assigned to the time taken by the second computing node to complete the task is based on the static power coefficients and the dynamic power coefficients of the second processor, and
the user defined weighted coefficient assigned to the energy consumed by the second computing node is based on the static power coefficients and the dynamic power coefficients of the memory usage of the second computing node.
